(19) United States
(12) Patent Application Publication
(10) Pub. No.: US 2026/0050110 A1
(43) Pub. Date: Feb. 19, 2026

(54) METHOD FOR ANGLED FEATURE FORMATION

(71) Applicant: Tokyo Electron Limited, Tokyo (JP)

(72) Inventors: Andrew Metz, Albany, NY (US); Angelique Raley, Albany, NY (US)

(21) Appl. No.: 18/807,728

(22) Filed: Aug. 16, 2024

(51) Int. Cl. G02B 5/18; H05H 1/30

(52) U.S. Cl. CPC G02B 5/1857; H05H 1/30

(57) ABSTRACT

A method for processing a substrate includes loading the substrate on a substrate holder coupled to a scanning tool and disposed in a processing chamber, the substrate including an etch mask disposed over an underlying layer. The method further includes orienting, using the scanning tool, the substrate holder relative to a plasma torch at a tilt angle, the plasma torch being disposed in the processing chamber and including a plasma nozzle, the tilt angle being an angle between the plasma torch and a normal direction of the substrate holder. And the method further includes generating, using the plasma torch, a plasma jet over an area of the substrate holder, and scanning, while maintaining a distance between an end of the plasma nozzle and a surface of the substrate, the substrate relative to the plasma jet to form features on the underlying layer at the tilt angle.

### TECHNICAL FIELD

The present invention relates generally to a system and method for processing substrates, and, in particular embodiments, to a system and method for forming angled features in a substrate.

### BACKGROUND

Optical gratings are fundamental components in a variety of photonic systems where control over light propagation is desired. These gratings have a series of fine, parallel lines or grooves that diffract light into various orders and are used to disperse light into its component wavelengths. The functionality and efficiency of an optical grating are dependent on the precision with which the grates' depth and angle are formed, as these parameters determine the grating's ability to manipulate the phase and amplitude of incoming light.

Conventional methods for creating optical gratings predominantly include holographic lithography, electron beam lithography, and interference lithography. Each of these methods comes with specific limitations in terms of flexibility and control over the grating parameters. For instance, while holographic lithography allows for the formation of periodic structures, it is often challenging to introduce variations in depth and angle without complex and costly setups. Electron beam lithography, on the other hand, offers high precision but tends to be time-consuming and less efficient for large-scale production. Interference lithography can produce large-area gratings but is generally limited to periodic structures with uniform depth and angle.

### SUMMARY

In accordance with an embodiment of this disclosure, a method for processing a substrate includes loading the substrate on a substrate holder coupled to a scanning tool and disposed in a processing chamber, the substrate including an etch mask disposed over an underlying layer. The method further includes orienting, using the scanning tool, the substrate holder relative to a plasma torch at a tilt angle, the plasma torch being disposed in the processing chamber and including a plasma nozzle, the tilt angle being an angle between the plasma torch and a normal direction of the substrate holder. And the method further includes generating, using the plasma torch, a plasma jet over an area of the substrate holder, and scanning, while maintaining a distance between an end of the plasma nozzle and a surface of the substrate, the substrate relative to the plasma jet to form features on the underlying layer at the tilt angle.

In accordance with yet another embodiment of this disclosure, method for processing a substrate includes forming an etch mask for an optical grating over a layer of glass, and loading the layer of glass with the etch mask into a plasma chamber including a plasma torch. The method further includes generating a plasma jet at an exit nozzle of the plasma torch. And the method further includes scanning the plasma jet over the etch mask, the plasma jet being tilted relative to a major surface of the layer of glass during the scan so as to form the optical grating in the layer of glass with tilted features.

And in accordance with yet another embodiment of this disclosure, a system for plasma processing includes a processing chamber, and a plasma torch disposed in the processing chamber and configured to emit a plasma jet along a vertical direction, the plasma torch coupled to a height motor to change a position of the plasma torch along the vertical direction. The system further includes a scanning tool coupled to a substrate holder in the processing chamber, the scanning tool configured to scan the substrate holder along a plane with a surface normal that is tilted relative to the vertical direction during a scanning operation. The system further includes an RF power supply electrically coupled to the substrate holder, a controller coupled to the scanning tool and the height motor, and a memory coupled to the controller and storing instructions to be executed in the controller. The instructions when executed cause the controller to synchronize the scanning tool with the height motor during the scanning operation.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1C illustrate a plasma torch disposed above a substrate at various heights during processing in accordance with an embodiment;

FIGS. 2A-2B illustrate cross-sectional views of a substrate throughout an angled feature forming process in accordance with an embodiment;

FIG. 3 illustrates a block diagram of a scanning tool in accordance with an embodiment;

FIGS. 4A-4B illustrate two cross-sectional views of a scanning apparatus loaded with a wafer in accordance with an embodiment;

FIGS. 5A-5C illustrate schematics of a scanning apparatus loaded with a wafer rotated through various angles, positioning the wafer at various tilt angles, in accordance with an embodiment;

FIG. 6A illustrates a perspective view of an exposed portion of the scanning apparatus of FIG. 4B;

FIG. 6B is a schematic illustration of the portion of the scanning apparatus of FIG. 6A;

FIG. 6C is a detailed zoomed in schematic illustration of a portion of the scanning apparatus of FIG. 6B;

FIG. 7 illustrates a top view of a parallel raster pattern superimposed over a substrate in accordance with an embodiment;

FIG. 8 is a flowchart of an embodiment method of forming angled features on a substrate; and

FIG. 9 is a flowchart of an embodiment method of forming angled features on a substrate.

### DETAILED DESCRIPTION OF ILLUSTRATIVE EMBODIMENTS

Given the diverse range of applications that benefit from tailored light manipulation, there is a need for a method capable of efficiently fabricating optical gratings that allows for variable depth and angle within a single grating structure. Such a method would enable the creation of gratings that can be customized for specific functions, such as producing optimized diffraction patterns or enhancing light-matter interactions for sensors and spectrometers.

Advancements in this area could unlock new possibilities in producing highly specialized optical components that meet the exacting demands of modern photonic systems. Such systems may use gratings with non-uniform profiles to shape light in ways that homogeneous gratings cannot achieve, implying a more versatile method of formation may be beneficial.

Variable depth and angle optical gratings could provide significant performance improvements in terms of spectral resolution, diffraction efficiency, and signal-to-noise ratio. Engineers and designers in the field of photonics could harness such capabilities to develop more advanced optical devices and systems with enhanced functionality.

Traditional substrate processing systems and methods are capable of fabricating features on semiconductor wafers with both location specific processing (for variable depth control) and angle control, such as ion beam etching (IBE) systems or gas cluster systems, but have slow removal rates of materials. Other traditional substrate processing systems and methods are capable of fabricating features on semiconductor wafers with control over the angle of the features and with high removal rates of materials, but do not comprise location specific processing for variable depth control, such as reactive ion etching (RIE) systems.

This disclosure describes embodiment systems and methods for processing a substrate with both location specific processing and angle control while maintaining high removal rates of materials. To accomplish this, the embodiment systems of this disclosure use a plasma torch coupled to a height controlling mechanism. The plasma torch emits a plasma jet over an area of a substrate holder, and can be scanned across the wafer with a scanning apparatus capable of orienting the substrate holder at a tilt angle with respect to the direction of the plasma jet and capable of scanning a semiconductor wafer through the plasma jet in various raster patterns.

A benefit of the embodiment systems and methods of this disclosure is, by enabling both location specific processing and angle control, the systems and methods may be used to fabricate features with control of the angle and with variable depths across a die while maintaining a high removal rate. Another benefit is that by maintaining a high removal rate, the processing time for a substrate is smaller than conventional systems. Another benefit is that the embodiment systems of this disclosure may be used to fabricate optical gratings (which may be used in augmented reality (AR) and virtual reality (VR) applications) faster than conventional systems. And another benefit of the embodiment systems of this disclosure is the control of the angle and the variable depth control may be used to fabricate various different semiconductor structures at different angles to the plasma jet direction in the same system. For example, vertical contact holes and angled trenches may both be fabricated in the substrate processing system of this disclosure.

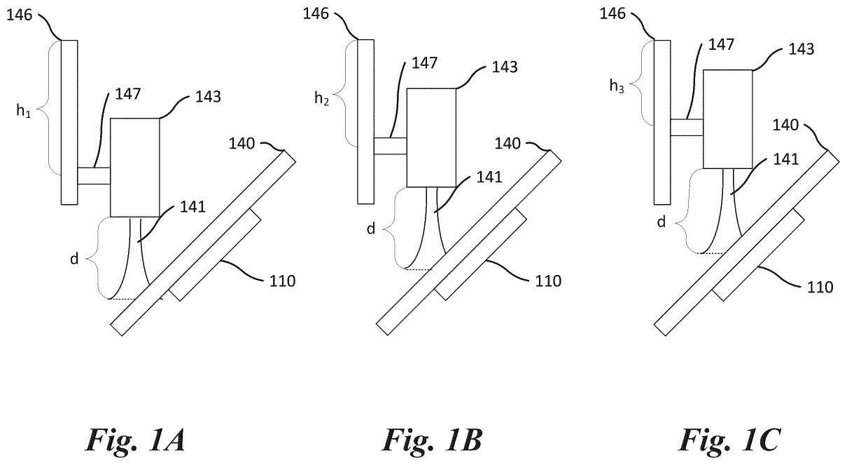

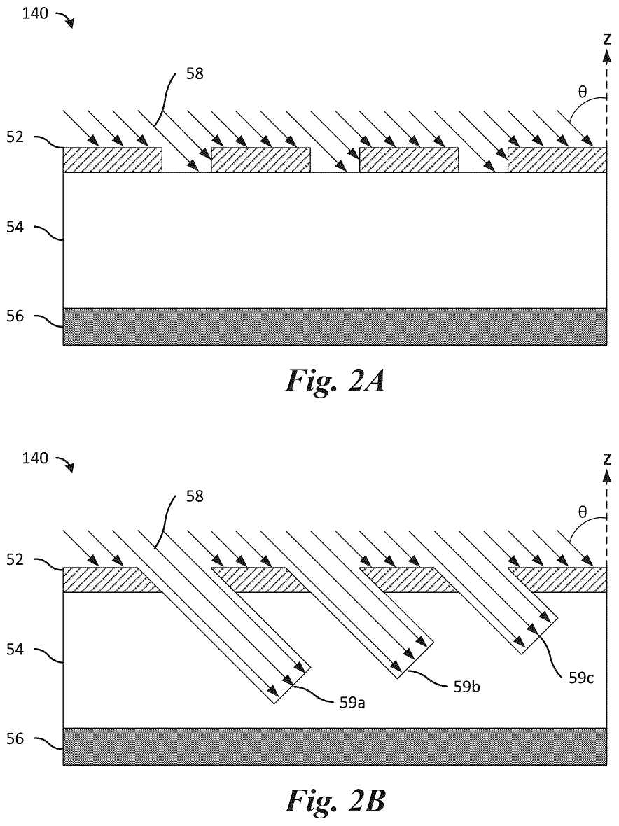

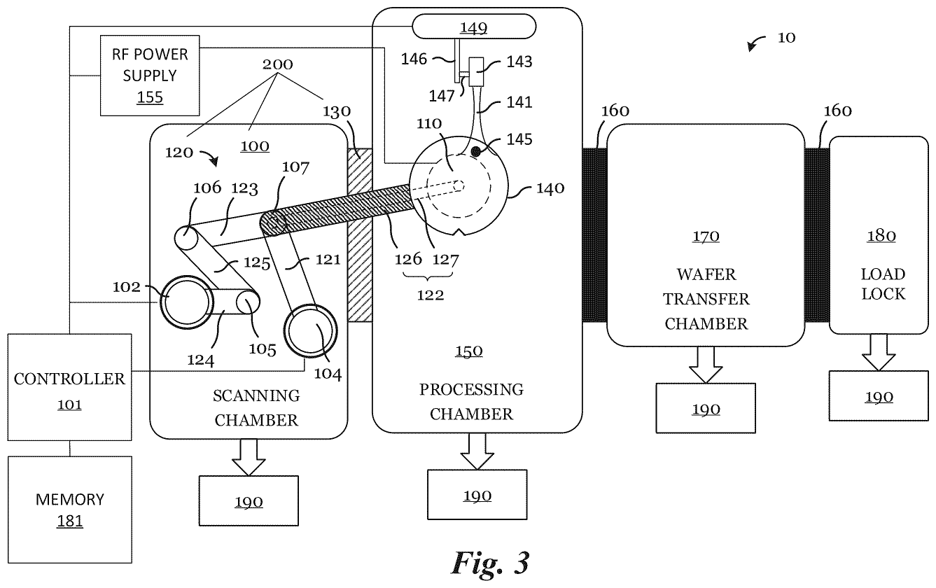

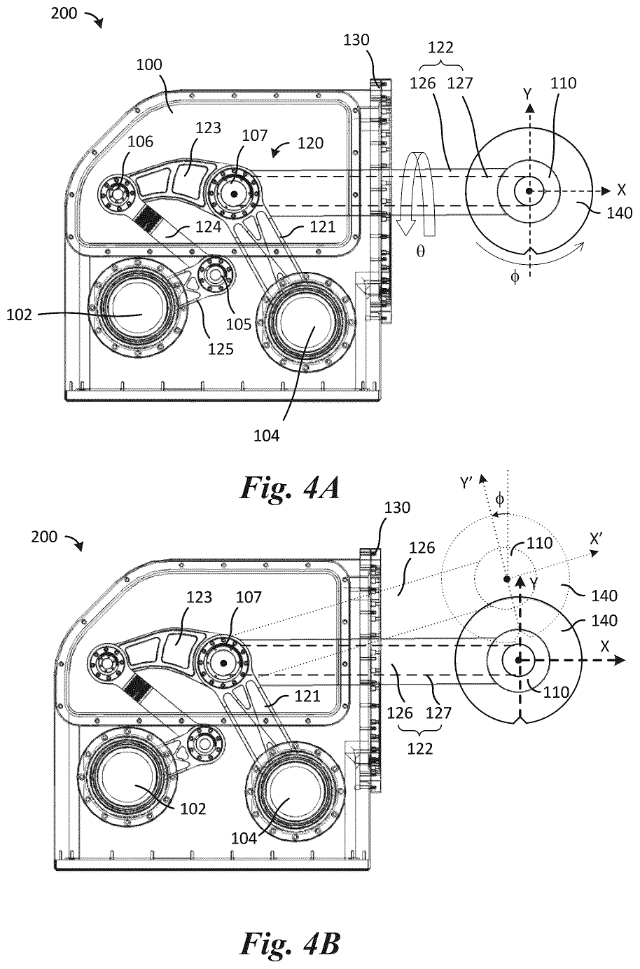

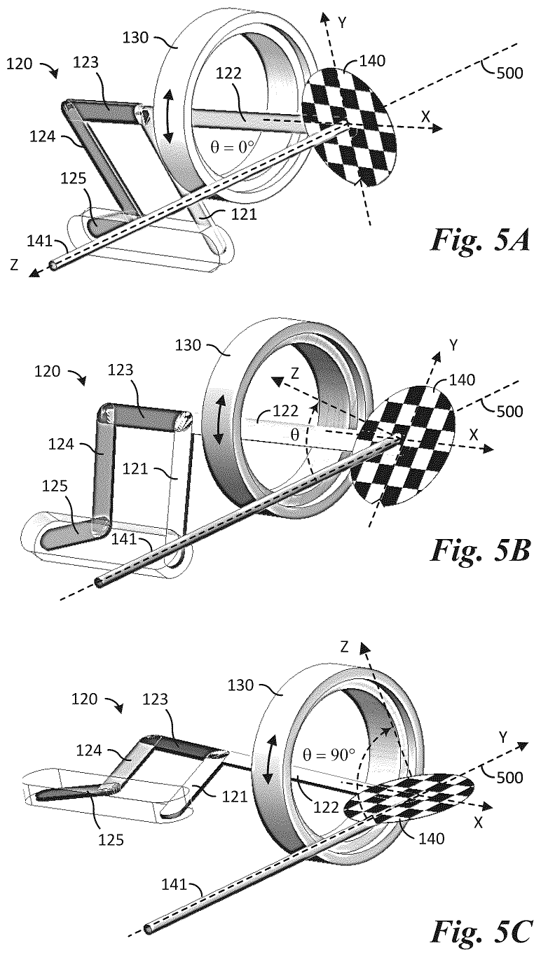

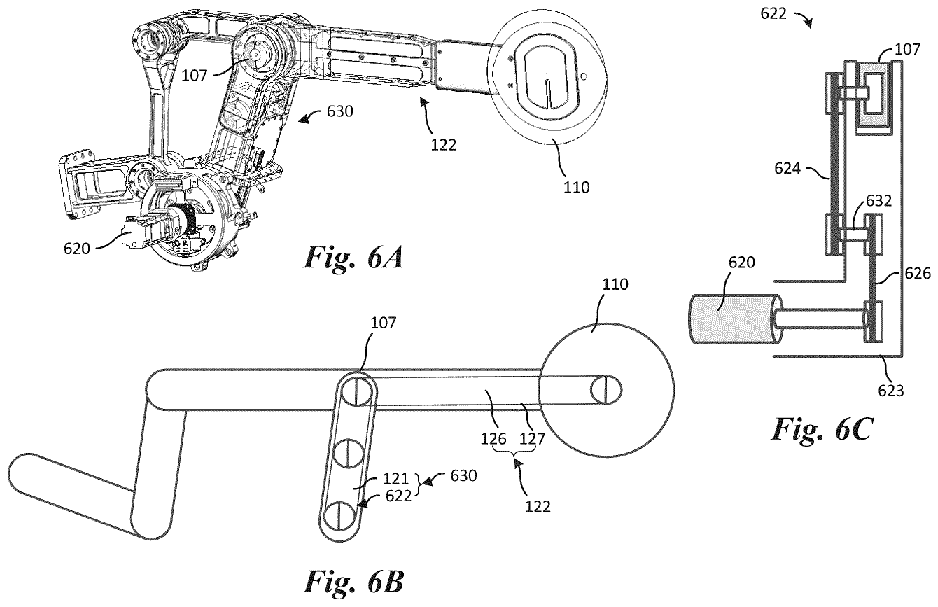

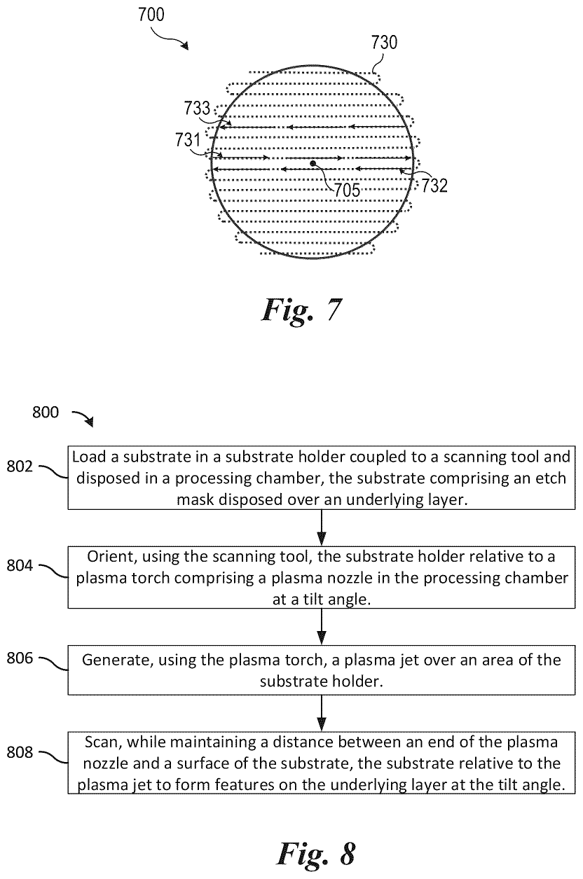

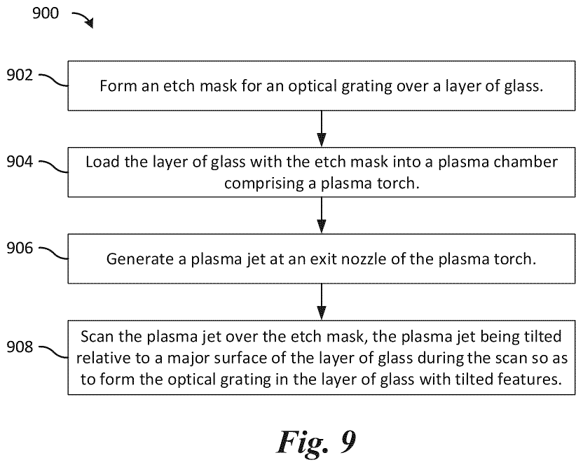

Embodiments provided below describe various systems, apparatuses and methods for processing a substrate, and in particular, processing the substrate to form angled features with location specific processing while maintaining a high material removal rate. The following description describes the embodiments. FIGS. 1A-1C and 2A-2B are used to describe an embodiment processing method including height control of a plasma torch. FIGS. 3 and 4A-4B are used to describe an embodiment scanning tool. An example of the motion of an embodiment scanning apparatus to enable angled processing and location-specific processing for variable depth control is described using FIGS. 5A-5C. A geometric zoomed in diagram of an embodiment pendulum arm and corresponding belt and pulley system is described using FIGS. 6A-6C. An embodiment parallel raster pattern is described using FIG. 7. And embodiment substrate processing methods are described using FIGS. 8-9.

FIGS. 1A-1C illustrate a wafer 140 oriented at a tilt angle throughout a processing method in comparison to a plasma jet 141 emitted by a plasma torch 143 to form angled features at a high material removal rate (e.g., etch rate) in accordance with an embodiment of this disclosure. As the wafer 140 is scanned using a scanning tool, such as the scanning tool described below using FIG. 3, a distance between a plasma nozzle (or exit nozzle) of the plasma torch 143 may be kept the same throughout the processing method using a height motor 146 to ensure an area of the surface of the wafer 140 exposed to the plasma jet 141 remains the same size. The distance may be used to control the material removal rate and amount of time different regions of the surface of the wafer 140 are exposed to the plasma jet 141 (by increasing or decreasing the area of the wafer 140 exposed to the plasma jet 141).

Each of FIGS. 1A-1C illustrate the wafer 140 disposed on a substrate holder 110 at some point in a scan with the plasma torch 143 emitting the plasma jet 141 at a distance over the wafer 140. A torch arm 147 couples the plasma torch 143 and the height motor 146 to enable the height motor 146 to control and modify the distance, d, between the surface of the wafer 140 and the plasma nozzle of the plasma torch 143. The wafer 140 is tilted at a tilt angle, which is an angle between a normal direction of the surface of the wafer 140 and the direction of the plasma jet 141.

FIGS. 1A-1C illustrates height control of the plasma jet during processing of the wafer 140 in accordance with an embodiment of this disclosure. During the scanning of the wafer 140 disposed on the substrate holder 110 by the scanning apparatus (such as scanning apparatus 200 illustrated in FIGS. 4A-4B), the height motor 146 may be used to adjust a height between the wafer 140 and the plasma jet 141 to maintain an area as the same size throughout processing the wafer 140. Specifically, when a scanning tool is configured to maintain the tilt angle of the wafer 140 throughout the scan, the wafer 140 may be moved within the plane of the surface of the wafer 140 in a manner that results in the wafer 140 moving closer or further away from the plasma torch 143. In various embodiments, it may be advantageous to use some form of height control apparatus to maintain the distance between the plasma nozzle of the plasma torch 143 and the surface of the wafer 140 being processed.

The plasma jet 141 can include plasma effluent, ionized species, neutral or non-ionized species, radical or dissociated species, metastable species, or combinations thereof. The plasma jet 141 can be tailored to emit one or more species substantially exclusive of others, i.e., emit neutral species while substantially omitting ionized species. The plasma jet 141 can be formed using plasma generated remotely or in-situ with the plasma nozzle. In the latter, plasma-generating elements can be coupled to the conduit flowing gas(es) through the plasma nozzle.

The wafer 140 may be any suitable substrate for which scanning of an exposed surface is desired to process the wafer 140 and form angled features. In various embodiments, the wafer 140 is a substrate, or is a silicon wafer, or is glass to form an optical grating. More possible substrates include flat panel displays, photolithography masks, and others. Although the many wafers are circular, there is no limiting specification for the wafer 140 to be circular or even substantially circular. For example, the wafer 140 may be circular, square, rectangular, or any other desired shape including irregular shapes. Further, the substrate holder 110 may be any suitable substrate holder for holding the wafer 140 throughout the scanning process of the methods of this disclosure. For example, the substrate holder 110 may be a vacuum chuck. In general, the substrate holder 110 is not biased to avoid non-perpendicular electric field lines. To avoid biasing the substrate holder 110, the energy imparted by the plasma source/ion extraction may be used to achieve directionality and therefore anisotropy. Some embodiments may include an electron gun to remove charge accumulated on the substrate/substrate holder 110 during processing. Embodiments may also be operated to avoid plasma sheath formation so as to avoid sheath from accelerating ions normal to the surface of the substrate holder 110. In some embodiments, the substrate holder 110 may be an electrostatic chuck comprising various concentric rings for maintaining an electric field suitable for controlling the exposure of the wafer 140 to the plasma jet 141 throughout processing. In an embodiment where the substrate holder 110 is an electrostatic chuck, the concentric rings may be biased at various different potentials in order to form an electric field along the beam direction the plasma jet 141 is emitted from the plasma nozzle of the plasma torch 143.

FIG. 1A illustrates a first height, h₁, of the torch arm 147 from the top of the height motor 146 which results in an offset, d, between the plasma torch 143 and the wafer 140. As the wafer 140 is scanned through the plasma jet 141 by the scanning apparatus in accordance with the processing method of this disclosure, the height motor 146 may be used to ensure the offset remains the same in all scan positions. At a second scan position, FIG. 1B illustrates the modification by the height motor 146 to a second height, h₂, such that the offset, d, remained the same despite the wafer 140 being in a new position under the plasma jet 141. And at a third scan position, FIG. 1C illustrates the modification by the height motor 146 to a third height, h₃, such that the offset, d, remained the same despite the wafer 140 being in a second new position. As a result, the scanning tool 10 of this disclosure may also vary the height of the plasma torch 143 over the wafer 140 throughout processing to improve material removal rates and maintain consistent etch profiles across the surface of the wafer 140. Thus, the LSP and angled feature formation of the processing method of this disclosure are improved using the height motor 146.

In various embodiments, the plasma jet 141 may plume as a result of transverse diffusion from repulsive electromagnetic forces between similarly charged ions of the plasma forming the plasma jet 141. At the outer regions of the plume, the plasma particles may scatter and reflect from the surface of the wafer 140. Embodiments of the plasma torch 143 may comprise a vacuum system to collect the backscattered plasma particles from the outer regions of the plume to further control the material removal rate of layers being processed on the wafer 140. Additionally, in various embodiments, walls of the processing chamber (such as a reactive ion etching (RIE) chamber) may also collect backscattered plasma particles or ions.

To enable the LSP of the wafer 140, a scanning tool may be used. In various embodiments, the scanning tool may be coupled to the substrate holder 110 and be configured to move the substrate holder 110 beneath the plasma torch 143 to scan the surface of the wafer 140 with the plasma jet 141 to form angled features. The scanning tool may also be configured to maintain the tilt angle throughout processing to form angled features. And FIGS. 2A-2B illustrate processing steps to form angled features, in accordance with an embodiment of this disclosure.

FIG. 2A illustrates a cross-sectional view embodiment of a region of the wafer 140 comprising an etch mask 52 disposed over a layer to be patterned 54 which is disposed over an underlying layer 56. Further, FIG. 2A illustrates a step of the processing method of this disclosure as the wafer 140 is scanned beneath the plasma jet (such as the plasma jet 141 described above in FIGS. 1A-1C). In FIG. 2A, plasma particles 58 are colliding with the exposed regions of the etch mask 52 to start forming angled features using LSP at a high material removal rate (e.g., an etch rate). In various embodiments, various processing parameters may be adjusted to configure an etch rate of the plasma jet (or some other processing tool used in different embodiments, such as a gas cluster tool), and the etch rate may be between about 10 nm/min to 10,000 nm/min. The tilt angle, θ, is illustrated as the angle between the normal direction of the surface of the wafer 140 and the direction of the plasma jet (or plasma particles 58 from the plasma jet). The substrate processing method of this disclosure uses a scanning tool to enable LSP for variable depth control and to enable angled feature formation.

In various embodiments, the etch mask 52 may be any suitable material for use as an etch mask to form the angled features of the substrate processing methods of this disclosure. Further, the etch mask 52 may have been deposited through conventional processes and using conventional techniques. In some embodiments, the etch mask 52 may be a patterned photoresist layer.

Using a scanning tool with LSP for variable depth control and to form angled features enables various features to be formed across the surface of the wafer 140. FIG. 2B illustrates a region of the wafer 140 where different portions have been exposed to the plasma particles 58 of the plasma jet with different parameters to form features 59a-59c in the layer to be patterned 54 with various etch depths. For example, the feature 59a is an angled feature formed at the tilt angle, θ, and has been etched the largest amount to a first depth. Further, feature 59c is also an angled feature at tilt angle, θ, which has been etched to a third depth which is less than the first depth. And feature 59b is also an angled feature at tilt angle, θ, and has been etched to a second depth between the first depth and the third depth.

In various embodiments, the variable depths illustrated in the angled features 59a-59c may be controlled using the LSP enabled by the scanning tool of this disclosure. By varying different processing parameters (such as, etch rate, plasma jet energy, distance between the wafer and the plasma torch, exposure time, scan rate, etc.), etch depth may be controlled. In comparison to conventional techniques, the substrate processing systems and methods of this disclosure may perform LSP at variable tilt angles faster due to the high material removal rate. Additionally, the scanning tool enables angled features to be formed by scanning at the tilt angle. In various embodiments, the angled features which may be formed may be angled pillars, angled trenches, or angled contacts.

In various embodiments the substrate processing method of this disclosure may be used to form optical gratings, and the various layers of the wafer 140 may be suitable materials for forming the optical grating. For example, in an embodiment, the layer to be patterned 54 may be glass, or silicon. The underlying layer 56 may be any suitable material or composition of components suitable for forming the device using the substrate processing method of this disclosure. For example, the underlying layer 56 may comprise ICs, or may be a layer of silicon. In some embodiments, the angled features enabled by the scanning tool of this disclosure with high material removal rate may be used to more rapidly fabricate photonic integrated circuits, or other optical equipment which combines optical and electrical devices, such as current augmented reality (AR) and virtual reality (VR) applications. An embodiment scanning tool capable of implementing the substrate processing method of this disclosure is described below using FIG. 3.

A scanning tool 10 is described with reference to a block diagram illustrated in FIG. 3. The scanning tool 10 may be used to implement the processing method of this disclosure with variable depth control (through location-specific processing (LSP)), and to form angled features with a high material removal rate. In the embodiment illustrated in FIG. 3, a plasma torch may be used to etch a wafer or substrate at a high etch rate.

The scanning tool 10 in FIG. 3 comprises a scanning chamber 100 that houses a scanning mechanism comprising actuators, moving parts, hinges, and a substrate holder 110, collectively referred to as a wafer scanner 120; a processing chamber 150 where a wafer 140 (loaded onto the wafer scanner 120) may intersect a plasma jet 141 emitted over an area 145 of the wafer 140 by a plasma torch 143 for processing the wafer 140, and comprising a plasma generator 149 configured to produce the plasma jet 141 emitted by the plasma torch 143 using a gas mixture, the plasma torch 143 is coupled to a torch arm 147 which is coupled to a height motor 146 and configured to enable the control of a height (or distance, or offset) between the plasma torch 143 and the wafer 140; and a tilt drive 130 between the scanning chamber 100 and the process chamber 150 through which a moving part of the wafer scanner 120 can access and move the wafer 140 within the processing chamber 150. The combined continuous motion of the movable parts of the wafer scanner 120 and discrete rotary motion of the scanning chamber 100 using the rotatable feedthrough 130 may provide the desired movements of the wafer 140 through the plasma jet 141 to complete the processing step while maintaining a processing height of the plasma torch 143 using the height motor 146. Though FIG. 3 illustrates the scanning tool 10 comprising a plasma torch apparatus, other embodiments may use a gas cluster system to emit gas clusters. Accordingly, in this embodiment, the scanning chamber 100, the wafer scanner 120, and the rotatable feedthrough 130 are together referred to as the scanning apparatus 200. The full range of motion of the wafer scanning apparatus 200 and of the wafer 140 relative to the plasma jet 141 impinging on its surface is described in further detail below.

In the embodiment illustrated in FIG. 3, the substrate holder 110 is electrically coupled to an RF power supply 155. The RF power supply 155 may be used to apply a bias voltage of variable processing parameters to the substrate holder 110 to process the wafer 140 using the plasma jet 141. The variable processing parameters of the bias voltage to the substrate holder 110 may be used to control the material removal rate of various layers comprising different materials on the wafer 140. For example, an amplitude, a frequency, and a waveform (such as square-wave, or sine-wave, or others) are all variable processing parameters which may be adjusted according to a processing recipe to control the material removal rate from the wafer 140 by the plasma jet 141. In various embodiments, the amplitude of the bias voltage may be between about 5 eV and about 2000 eV, and the frequency of the bias voltage may be between about 100 kHz and about 1000 kHz.

In various embodiments, the bias voltage applied to the substrate holder 110 may be a DC bias, and the RF power supply 155 may be capable of generating and applying the DC bias. Further, the DC bias may comprise a square wave with an amplitude between about 10-100 eV, and with a frequency between about 100-1000 kHz.

An advantage of the scanning tool 10 of this disclosure is the ability to perform LSP at an angle at a high material removal rate (such as an etch rate using the plasma jet 141). The RF power supply 155 may be any conventional power supply capable of applying the bias voltage to the substrate holder 110 with the variable processing parameters prescribed by the processing recipe. Further, the bias voltage applied to the substrate holder 110 may be used to ensure an anisotropic etch occurs using the plasma torch 143 and to avoid bowing and other feature defects, and to form smooth sidewalls in the features being etched (or processed).

An additional processing parameter which may be configured to control the material removal rate is a gas mixture used to form the plasma jet 141. In other words, the gas mixture may comprise different mixtures of gases specifically tailored to the material of the wafer 140 to be removed (or etched). For example, in various embodiments, the gas mixture may comprise a mixture of SF₆ and O₂ to form the plasma jet 141. As another example, in other embodiments the gas mixture may comprise a mixture of BCl₃ and Cl₂. Other potential gas mixtures may comprise any material selective gas mixture capable of achieving anisotropic etch profiles in traditional RIE chambers, such as gas mixtures of SI, SF₆, NF₃, Cl₂, HBr, BCl₃+O₂, CO, CO₂+He, Ar, and Kr. Further, embodiments processing metals or metal oxides may use gas mixtures of SF₆, NF₃, Cl₂, HBr, BCl₃+He, Ar, and Kr. Standard dielectric embodiments may use gas mixtures of CF₄, CHF₃, CH₂F₂, CH₃F, C₄F₈, C₄F₆, C₃F₈, C₆F₆+O₂, CO₂, CO, H₂, Ar, and Kr. And embodiments with mask materials comprising organics may use gas mixtures of O₂, CO₂, CO, COS, SO₂, N₂, H₂, Ar, He, and Kr.

The scanning tool 10 further includes a load lock 180, where wafers for processing may be placed, and a wafer transfer chamber 170, as illustrated in FIG. 3. The wafer 140 may be transported from the load lock 180 to the substrate holder 110 of the wafer scanner 120 using, for example, an (r, θ, z) robotic arm located in the wafer transfer chamber 170. A wafer transfer window in the processing chamber 150 may be used to transfer the wafer 140 from the wafer transfer chamber 170 to the substrate holder 110.

The scanning tool 10 further includes a controller 101 to control the rotary drives of the scanning apparatus 200, the bias voltage applied to the substrate holder 110 by the RF power supply 155, and the plasma generator 149 to control the generation of the plasma jet 141 (such as the ignition of the gas mixture described above) and the height between the plasma torch 143 and the wafer 140 using the height motor 146 as was described using FIGS. 1A-1C. The controller 101 may be used to implement the processing method of this disclosure by executing instructions stored in a memory 181. The memory 181 may be any suitable storage device capable of storing the instructions to be executed by the controller to implement the processing method embodiments of this disclosure.

As illustrated in FIG. 3, the scanning tool 10 may comprise a vacuum system 190 connected to the scanning chamber 100, the process chamber 150, the wafer transfer chamber 170, and the load lock 180. The connection between the scanning chamber 100 and the processing chamber 150 may be controlled by a rotary seal in the rotatable feedthrough 130, and the connections between the load lock 180, the wafer transfer chamber 170, and the processing chamber 150 may be controlled by two gate valves 160, as indicated schematically in FIG. 3. In one embodiment, this allows each chamber of the scanning tool 10 to be isolated and maintained at an independently controlled pressure using, for example, throttle valves. One advantage of having separate scanning and processing chambers is that it helps protect moving parts of the wafer scanner 120 from contaminants originating in the processing chamber 150. In one embodiment, controlled pressure difference between the scanning chamber 100 and the processing chamber 150 may be maintained to prevent byproducts produced inside the processing chamber 150 during processing from entering the scanning chamber 100 and being deposited on the parts of the wafer scanner 120.

The scanning tool 10 may be used to perform the substrate processing method of this disclosure using location-specific processing (LSP) and form angled features at high material removal rates. To enable both the LSP and formation of angled features, the scanning tool 10 uses the scanning apparatus 200, which may be described using the diagrams illustrated in FIGS. 4A-4B.

FIG. 4A illustrates a cross-sectional view of a prototype of the scanning apparatus 200 shown schematically in FIG. 3. In one embodiment, two rotary drives (a first rotary drive 102 and a second rotary drive 104) are used as the primary actuators of the wafer scanner 120. One advantage of using rotary drives is cleanliness, hence lower maintenance cost because, unlike linear bearings, rotary bearings may be sealed from contaminants in the ambient environment. Synchronous angular displacements of the first and the second rotary drives 102 and 104 may be accurately computed in accordance with a desired planar trajectory of the center of the substrate holder 110, and subsequently used by a controller 101 (FIG. 3) to generate the computed synchronized rotational motions with high precision using, for example, electronically controllable motors. Control of backlash in the mechanical design of rotary parts may be beneficial for precise positioning of the wafer 140. Generally, the choices of drives, couplings and bearings are made to reduce backlash. The synchronized pair of rotations actuated by the first and the second rotary drives 102 and 104 is converted to a target scan trajectory of the center of the substrate holder 110 via various other moving parts of the wafer scanner 120. The trajectory of the substrate holder 110, hence, also the trajectory of the wafer 140 loaded onto the substrate holder 110, is substantially coplanar with (or parallel to) the processing surface of the wafer 140.

In one embodiment, the rotational motion of the first and the second rotary drives 102 and 104 may be translated to a planar motion along the plane of the surface of wafer 140 using a bar-and-hinge system comprising five bar links (a first bar link 121, a second bar link 123, a third bar link 124, a fourth bar link 125, and a belted fifth bar link 122), and three hinges (a first hinge 105, a second hinge 106, and a third hinge 107) about which the bar links can rotate.

The belted fifth bar link 122 comprises a bar link 126 and a motorized belt-and-pulley system 127 in the bar link 126. The motorized belt-and-pulley system 127 may be used to orient the wafer 140 by rotating the planar surface of the substrate holder 110 along with the wafer 140. In various other embodiments, the mechanism used to rotate the substrate holder 110 may be implemented differently, as discussed in further detail below.

As illustrated in FIG. 4A, the first and the second rotary drives 102 and 104 are affixed to the body of the scanning chamber 100. Each rotary drive rotates one end of a respective bar link directly connected to the drive.

In FIG. 4A, the fourth bar link 125 is attached to the first rotary drive 102 and, at the opposite end, to a free moving first hinge 105. The first bar link 121, attached to the second rotary drive 104, has its opposite end connected to another free moving third hinge 107. The pair of synchronized rotations of the actuated first and fourth bar links 121 and 125 (synchronized by the controller, as described above) causes a respective synchronized pair of displacements of the first and the third hinges 105 and 107. The first and the third hinges 105 and 107 transmit the motion to other bar links attached to the first and the third hinges 105 and 107.

First hinge 105 is attached to one end of the third bar link 124, and third hinge 107 is attached to one end of the second bar link 123. The opposite ends of the second and the third bar links 123 and 124 are both connected to the second hinge 106. This causes a motion of the second hinge 106 conforming to the trigonometric relations between the angles of a triangle having two sides determined by the lengths of two bar links (second and third bar links 123 and 124) and the third side being the line segment connecting the first and the third hinges 105 and 107. The distance between the first and the third hinges 105 and 107 is determined by a combination of their synchronized displacements described above. In one embodiment, the repositioning of second hinge 106 determines the trajectory of the center of the substrate holder 110 (and of the wafer 140), as explained herein.

One end of the belted fifth bar link 122 has been attached to the substrate holder 110 and the opposite end is attached to the third hinge 107 and the second bar link 123. The connection between the second bar link 123 and the belted fifth bar link 122 allows the two-bar combination to pivot around the third hinge 107 while the angle formed by the two bars is held fixed. Accordingly, in this embodiment of the wafer scanner 120, the location of the center of the substrate holder 110 is uniquely determined by the combined positions of second and third hinges 106 and 107 and the combined lengths of the second bar link 123 and the belted fifth bar link 122.

As illustrated in FIG. 4A, in one embodiment, the wafer 140 is placed on the substrate holder 110 such that the centers of the substrate holder 110 and wafer 140 are substantially coincident. The common center point is defined as the origin of a three-dimensional rectangular coordinate system (X, Y, Z), as illustrated in FIG. 4A and subsequent figures in this disclosure. The X-Y plane is the plane containing the planar trajectory derived from the synchronized rotations of the first and the second rotary drives 102 and 104, as described above. As illustrated in FIG. 4A, the X-Y plane is virtually same (or coplanar) as the surface of the wafer 140 (or the substrate holder 110). Accordingly, the Z-axis (not visible in the two-dimensional view in FIG. 4A) points in a direction normal to this surface. The direction of the Y-axis could be selected along any particular orientation in the plane of the wafer. For specificity, in the figures in this disclosure, the Y-axis is selected to pass through a wafer notch. It is also customary to indicate a particular orientation of a crystalline semiconductor substrate by a physical mark on the wafer, such as the notch near the circumference of the circular wafer 140 in FIG. 4A.

The angle formed by the Z-axis (or any other line normal to the X-Y plane) and the processing beam (e.g., the plasma jet 141) is referred to as the tilt angle, θ. In an embodiment, the Z-axis may be the normal direction of the substrate holder, which makes the tilt angle the angle between the normal direction of the substrate holder and the processing beam. In FIG. 4A, the surface of the wafer 140 is vertical with the notch towards the bottom and, it is implicitly assumed that the plasma jet 141 (or gas clusters in other embodiments) is incident horizontally perpendicular to the wafer surface, indicated as the X-Y plane. Accordingly, in FIG. 4A, tilt angle θ=0°. In one embodiment, one side of the rotatable feedthrough 130 is attached rigidly (e.g., bolted) on to a wall of the scanning chamber 100. The opposite side may be placed on rotary bearings attached to an adjacent wall of the processing chamber 150, thereby allowing the scanning chamber 100 to be rotated about an axis passing through the center of the tilt drive 130 and normal to the wall of the processing chamber to which the rotary part of the rotatable feedthrough 130 is attached. In one embodiment, the tilt angle, θ, may be adjusted by rotating the scanning chamber 100 and wafer scanner 120 using the rotatable feedthrough 130, as indicated by the curved arrow in FIG. 4A. The rotatable feedthrough 130 may rapidly rotate the wafer scanning apparatus 200 to adjust the tilt angle θ to any desired value. In one embodiment, θ could be varied over a 155° range (−90°≤θ≤65°), and the wafer could be moved from a horizontal loading position to a tilt of 65° in about 8 seconds to about 10 seconds. The plasma jet 141 remains stationary, except for a displacement between the wafer 140 and the plasma torch 143. As the wafer 140 is scanned through various positions at a configured tilt angle (θ) during processing, the height between the wafer 140 and the plasma torch 143 may be adjusted using the controller 101 to control the height motor 146 such that the size of the area 145 on the surface of the wafer 140 remains the same throughout processing (which is described using FIGS. 1A-1C above). The range may be limited during wafer processing. In one embodiment, the tilt angle is between −65° and +65° (−65°≤θ≤65°) during processing. In some other embodiments the range for θ may be larger. The tilted wafer 140 may be scanned through the plasma jet 141 by the wafer scanner 120 to perform the processing method of this disclosure with the plasma jet 141 striking the surface at a desired tilt angle. Beam processing with a tilt angle, θ, is illustrated in further detail below with reference to FIGS. 5A through 5C.

As mentioned above, the wafer is processed by scanning its surface through a stationary processing beam (e.g., a stationary plasma jet 141). In the embodiments described in this disclosure, the scan trajectory of any point on the wafer surface is coplanar with the roughly planar surface of the wafer, or equivalently, the scanning plane and the processing plane are coincident. One advantage of using scanning apparatus where the scanning plane is roughly the same as the processing plane is that the distance between the beam source and the beam spot (the spot where the wafer intersects the beam) is roughly constant throughout the scan, even at large tilt angles. This is advantageous in keeping the beam focused on the wafer during the entire wafer scan, thereby improving control over the size and shape of the beam spot and enable LSP. Further control over the size of the area 145 is enabled by controlling the height between the wafer 140 and the plasma torch 143 using the height motor 146 when the scanning plane is not the same as the processing plane.

In FIG. 4A and other figures in this disclosure, for specificity, it has been assumed that the scanning apparatus 200 is orientated such that the tilt drive 130 is roughly in a vertical plane, and the stationary plasma jet 141 used for processing the wafer is a horizontal beam. The direction of the stationary plasma jet 141 relative to the scanning apparatus 200 has been assumed to be such that the beam is directed perpendicular to the family of lines normal to the vertical plane of the rotatable feedthrough 130 intersecting the plasma jet 141.

Still referring to FIG. 4A, at any fixed tilt angle, θ, the wafer 140 may be rotated in-plane through a twist angle φ, without altering tilt angle θ, as indicated by an arc-shaped arrow in FIG. 4A. Generally, zero twist angle (φ=0°) is defined to be the orientation of the wafer 140 in FIG. 4A, where the notch is downwards when the wafer 140 is held vertically (θ=0°), perpendicular to a horizontal plasma jet 141. Since the Y-axis is defined as coincident with the diameter which passes through the notch, the twist angle, φ, is the angular position of the Y-axis relative to the Y-axis at φ=0°. Accordingly, the twist angle, φ, may be defined to be the angle formed between the X-axis and a reference axis perpendicular to the planar face of the rotatable feedthrough 130. In one embodiment, φ may be set to any value in the range 0°≤φ≤360°, where, by convention, twist angle φ is considered to be increasing with counterclockwise rotation and decreasing with clockwise rotation. For example, if the wafer 140 in FIG. 4A were rotated a quarter-circle counterclockwise about the Z-axis then the notch would be towards the right, and φ=90°. For a rotation through a half-circle, φ=180°, and φ=270° for another quarter-circle beyond that. Here, the Y-axis has been defined by the position of the notch, so altering the twist angle from 0° to φ is equivalent to rotating the X-Y axes about the Z-axis by a twist angle φ. The angles θ and φ are analogous to the polar angle and azimuthal angle, respectively, of a spherical coordinate system. Consider a wafer 140 positioned with a tilt angle, θ, and a twist angle, φ being scanned through a plasma jet 141 by the wafer scanner 120. Then θ is the angle formed by the Z-axis and the plasma jet 141, and φ is the angle formed by the Y-axis and an orthogonal projection of the plasma jet 141 on the X-Y plane.

In this embodiment, the wafer 140 may be loaded onto the substrate holder 110 at a particular wafer orientation (e.g., at φ=0°), and subsequently rotated about the Z-axis by a specified twist angle, φ. The loaded wafer 140 and the substrate holder 110 may be rotated together about an axis passing perpendicularly through the face of the tilt drive 130 by a tilt angle, θ, prior to moving the wafer through the processing beam (e.g., gas clusters or a plasma jet). The tilt angle θ of the wafer 140 relative to the plasma jet alters the angle at which the beam strikes the wafer surface and this influences the outcome of the processing (e.g., angle-dependence of etch rate). The twist angle may also influence the outcome of the processing. In-plane rotation through a twist angle φ, alters the position of the notch and, hence the orientation of all features formed on the wafer 140 (and crystal orientation if crystalline material is present, such as silicon) relative to the plasma jet. Although, this does not alter the tilt angle (0) of the wafer surface relative to the plasma jet, altering the twist angle φ may alter, for example, the geometrical impact of an etch on a feature such as a long and narrow trench, or affect a dopant profile through a crystal orientation effect such as implant channeling.

Accordingly, it may be desirable the scanning apparatus 200 provides the capability to reduce variations in the tilt angle and the twist angle during the wafer scan. The wafer 140 may be loaded onto the substrate holder 110, oriented at a desired pair of values for tilt angle θ and twist angle φ and scanned through the plasma jet 141 along a planar trajectory in the X-Y plane. The scanning motion generated using the rotary drives and the bar-and-hinge system of the wafer scanner 120 may not affect the tilt angle, θ. However, additional parts such as the motorized belt-and-pulley system 127 may be used to control the twist angle, φ along the scan trajectory, as discussed further below with reference to FIGS. 6A-6C. Embodiments for forming angled features at particular tilt angles would scan the wafer 140 while maintaining a tilt angle and a twist angle such that the angled features are formed at their corresponding prescribed tilt angle.

Generally, the values for tilt angle θ and twist angle φ are held roughly constant during a scan. For process steps where it is desired that the surface be exposed to the processing beam at several discrete combinations of tilt angle θ and twist angle φ the process recipe may be constructed to pass the wafer through several scans with the tilt and twist angles (θ, φ) combination being altered between successive scans. The twist angle may be adjusted without removing the wafer 140 from the substrate holder 110 using, for example, an electronically controlled motorized belt-and-pulley system 127.

Although the embodiments described in this disclosure are designed to maintain tilt and twist angles (θ, φ) roughly constant during a single scan of the entire wafer surface, it is understood that the scanning apparatus 200 may be modified to change the tilt angle θ, or the twist angle φ, or both in a single scan in a controlled manner. For example, one selected region of the wafer 140 may be scanned with one pair of values, a first pair of tilt and twist angles (θ₁, φ₁), the scan halted to change the controlled orientation to a different pair of values, a second pair of tilt and twist angles (θ₂, φ₂). After the change in orientation, a different region of wafer 140 may be scanned using the new pair of values, the second tilt and twist angles (θ₂, φ₂). The tilt angle, or the twist angle, or both may be dynamically controlled while the wafer 140 is being scanned through the beam. As mentioned above, in order to maintain a constant twist angle, φ, while the wafer 140 is scanned in the X-Y plane, the wafer 140 may be rotated dynamically without removing the wafer 140 from the substrate holder 110.

As described above with reference to FIG. 4A, and illustrated in FIG. 4B, the fifth bar link 126, by itself, is without the motorized belt-and-pulley system 127. The fifth bar link 126 and the motorized belt-and-pulley system 127 may be combined to form the belted bar link 122. With the motorized belt-and-pulley system 127 of the belted fifth bar link 122, the planar surface of the substrate holder 110 (together with the wafer 140) may be able to rotate relative to the fifth bar link 126 of the belted fifth bar link 122. The rotation, being about the central axis normal to the planar surface, alters the twist angle, φ; hence the drive for the motorized belt-and-pulley system 127 is referred to as the twist drive. In one embodiment, the twist drive for the twist angle adjustment is embedded in the belted fifth bar link 122. In some other embodiments, the twist drive may be embedded in some other bar link.

FIGS. 5A-5C schematically illustrate beam processing (e.g., gas cluster processing, or plasma jet processing) of a wafer 140 by scanning the wafer 140 through a horizontal stationary plasma jet 141 directed along a beam line 500. The wafer 140 is shown loaded on the wafer scanner 120 (comprising the five bar links (first, second, third, and fourth bar links 121, 123, 124, and 125 and belted fifth bar link 122), described above with reference to FIG. 4A, and rotated by the rotatable feedthrough 130 to various tilt angles (θ).

In FIG. 5A, the plasma jet 141 is illustrated to be incident perpendicular (θ=0°) to the surface of the wafer 140. Accordingly, the Z-axis in FIG. 5A is coincident with the beam line 500. FIG. 5C, illustrates the wafer 140 tilted to a horizontal position (θ=90°), similar to what may be used to transfer the wafer from a wafer transfer window. Accordingly, the Y-axis in FIG. 5C is coincident with the beam line 500. An intermediate tilt angle, θ, is illustrated in FIG. 5B. In all the three FIGS. 5A, 5B, and 5C, the twist angle φ=0°. Accordingly, it may be noted that, if the plasma jet 141 were projected onto the X-Y plane, the projection would coincide with the Y-axis.

In various embodiments, the controller 101 in FIG. 3 may be used to control the first and second rotary drives 102 and 104 such that various tilt and twist angles (θ, φ) are maintained throughout processing of a wafer. Specifically, the twist angle (φ) may be controlled by the second rotary drive 104 or a twist drive, and various embodiments to accomplish such are described using FIGS. 6A-6C.

In an embodiment, described with reference to FIGS. 6A-6C, the twist drive may be coaxial with the rotary drive 104 and may include a motorized belt-and-pulley systems embedded to rotate the substrate holder 110 in order to control the twist angle, φ.

FIG. 6A illustrates a perspective view of a scanning apparatus wherein the twist drive is coaxial with the second rotary drive 104. As illustrated in FIG. 6A, a first motor may provide the drive for the bar links, while a second motor 620, coaxial with the first motor, may be used to drive a belt-and-pulley system via which the substrate holder 110 may be rotated to control the twist angle, φ. The belt-and-pulley system is illustrated in FIGS. 6A-6C.

A perspective view of the belted bar links 630 and 122, used to adjust the twist angle is shown in FIG. 6A and a schematic view illustrated in FIG. 6B indicates the belt-and-pulley systems 127 and 622 embedded in the fifth bar link 126 and the first bar link 121, respectively. The belted bar link 122, comprising the fifth bar link 126 and the belt-and-pulley system 127 in the scanning apparatus, may be similar to the belted bar link 122 in the scanning apparatus 200, described above with reference to FIG. 4B. While the belt-and-pulley system 127 in FIG. 6B uses one belt, the belted bar link 630 comprises a belt-and-pulley system 622 comprising two belts.

FIG. 6C illustrates a zoomed in schematic of the dual belt belt-and-pulley system 622. The second motor 620 used to drive the belt-and-pulley systems 127 and 622 is shown coupled to pulleys for the first belt 626. As illustrated in FIG. 6C, the second motor 620 and the first belt 626 are disposed in a compartment 623 that may be at atmospheric pressure. A rotary vacuum feedthrough 632 couples the first belt 626 with a second belt 624 by connecting two pulleys on opposite sides of the rotary vacuum feedthrough 632. As illustrated in FIG. 6C, one of the two pulleys is connected to the first belt 626 in atmospheric pressure, while the other pulley is connected to the second belt 624 in vacuum. The second belt couples the twist drive to the belt-and-pulley system 127 of the belted bar link 122 via the third hinge 107. As described above with reference to FIG. 4B, and illustrated in FIGS. 6A through 6B, the belted bar link 122 is coupled to the substrate holder 110.

The additional degree of freedom of rotation provided to the substrate holder 110 by motorized belt-and-pulley systems (e.g., belt-and-pulley systems 127 and 622) may maintain the orientation of the wafer notch and, hence, the twist angle, constant during the scan. (In this example, φ=0°). The rotary bearings used for the motorized belt-and-pulley system 127 of the belted fifth bar link 122 may be sealed from contaminants, as mentioned above in the context of the first and the second rotary drives 102 and 104 described with reference to FIG. 4A.

Unlike the horizontal bar link 126 of the belted fifth bar link 122, the inclined fifth bar link 126 (shown in dotted lines in FIG. 4B) does not include the motorized belt-and-pulley system 127. In the absence of the motorized belt-and-pulley system 127, the substrate holder 110 (drawn as a dotted circle in FIG. 4B) is rigidly connected to the inclined fifth bar link 126. Accordingly, the wafer notch deviates from the position with which the wafer 140 was initially placed on the substrate holder 110 of the scanning apparatus 200. For example, as illustrated in FIG. 4B, the notch was initially towards the bottom or, equivalently, the Y-axis was vertical (φ=0°). As the bar link gets inclined, the X-Y plane of the wafer 140 rotates by the same angle by which the fifth bar link 126 gets inclined. The rotated X and Y axes, denoted as X′ and Y′ in FIG. 4B, illustrate the deviation of φ from its initial value of 0°.

As explained above, in the absence of active twist angle control, the change in the inclination of the fifth bar link 126 during a scan causes a respective deviation of φ from its initial value. The deviation, Δφ, may be changing continuously in tandem with the dynamically changing position of the wafer 140 as it is moved in the X-Y plane. The controller 101 (see FIG. 3) may be programmed to synchronize the motorized belt-and-pulley system 127 with the circular motion of the rotors 102 and 104 to maintain Δφ at roughly zero degrees. The synchronous active twist angle control may maintain the desired twist angle, φ, during a scan. It may also vary φ, if it is desirable to use a different twist angle in different regions of the wafer 140.

FIG. 7 illustrates a top view of a parallel raster pattern superimposed over a substrate in accordance with an embodiment of this disclosure. The substrate of FIG. 7 may be a specific implementation of other substrates described herein such as wafer 140 of FIG. 3, for example.

Referring to FIG. 7, a parallel raster pattern 730 is illustrated superimposed over a substrate 700 to show how such a pattern might cover the entire substrate 700. The parallel raster pattern 730 includes a series of parallel paths that, in the aggregate, entirely cover the region of the substrate 700 that is to be scanned. Although there is no limitation on the specific pattern that may be used, in some embodiments, the parallel raster pattern is a linear raster pattern including a series of parallel straight (or substantially straight) lines that extend from one side of the substrate 700 to the other as shown. Each section of the parallel raster pattern 730 extending from one side of the substrate 700 to the other may be referred to as a pass 733. The parallel raster pattern 730 may not change direction while over the substrate 700 (as illustrated). This may have the advantage of ensuring very consistent exposure of the substrate 700 during scanning.

For this particular implementation of a parallel raster pattern, each consecutive pass of the parallel raster pattern 730 travels the opposite direction as the previous pass. For example, a first pass 731 may be scanned from left to right as shown so that a second pass 732 is scanned from right to left and so on. Although the parallel raster pattern 730 may begin at the end points of the path, it may also begin at any point in the middle (e.g. when scanning half of the substrate at a time which is discussed later on). It should also be noted that the parallel raster pattern 730 may or may not pass directly through the center 705 of the substrate 700 due to the finite (often Gaussian) nature of the spot size.

Although the parallel raster pattern 730 is shown and described as covering the entire substrate 700, partial coverage as well as partial processing is also possible. For example, the processing apparatus may be switched off for some portions of the pattern in order to only process certain regions of the substrate 700. Similarly, parameters of the substrate process (e.g. intensity, duration, etc.) may be changed in real time during scanning to alter processing at various portions of the substrate 700 relative to other portions of the substrate 700. In some cases, a partial raster pattern may be used (e.g. if locations on the substrate 700 specified for processing are grouped together or represent a relatively small fraction of the total substrate area).

This ability to dynamically vary processing parameters while scanning in combination while only scanning portions of a substrate may advantageously allow targeted processing of specific areas of the substrate (e.g. identified as having correctable defects or that need to be processed without harming other portions of the substrate, or regions are prescribed to form angled features and other regions of the substrate comprise vertical features etc.).

FIGS. 8-9 illustrate example methods of processing a substrate in accordance with embodiments of the disclosure. The methods of FIGS. 8-9 may be combined with other methods and performed using the systems and apparatuses as described herein. For example, the methods of FIGS. 8-9 may be implemented in the scanning tool 10 of FIG. 3. Although shown in a logical order, the arrangement and numbering of the steps of FIGS. 8-9 are not intended to be limited.

Referring to FIG. 8, step 802 of a method 800 of processing a substrate loads a substrate on a substrate holder coupled to a scanning tool and disposed in a processing chamber, the substrate comprising an etch mask disposed over an underlying layer. After, the method 800 orients, using the scanning tool, the substrate holder relative to a plasma torch comprising a plasma nozzle in the processing chamber at a tilt angle in step 804. Step 806 of the method 800 generates, using the plasma torch, a plasma jet over an area of the substrate holder. And the method 800, in step 808, scans, while maintaining a distance between an end of the plasma nozzle and a surface of the substrate, the substrate relative to the plasma jet to form features on the underlying layer at the tilt angle.

Now referring to FIG. 9, step 902 of a method 900 of processing a substrate forms an etch mask for an optical grating over a layer of glass. In an embodiment, the layer of glass may be the layer to be patterned illustrated in FIGS. 2A-2B. After, in step 904, the method 900 loads the layer of glass with the etch mask into a plasma chamber comprising a plasma torch. Step 906 of the method 900 generates a plasma jet at an exit nozzle of the plasma torch. And the method 900, in step 908, scans the plasma jet over the etch mask. Further, in step 908, the plasma jet may be tilted relative to a major surface of the layer of glass during the scan so as to form the optical grating in the layer of glass with tilted features.

Both method 800 of FIG. 8 and method 900 of FIG. 9 may be implemented in the scanning tool 10 illustrated in FIG. 3. Though various embodiment scanning tools described throughout this disclosure use systems of moving a substrate holder under a processing tool configured to move in only one direction, other embodiments may be possible. For example, other embodiments may scan a substrate holder that may be tilted to a tilt angle, but is otherwise stationary while the processing tool can move freely to scan a substrate. As another example, other embodiments may use a stationary substrate holder and angle the processing tool relative to a normal surface of the wafer disposed in the substrate, and etcetera.

Example embodiments of the invention are described below. Other embodiments can also be understood from the entirety of the specification as well as the claims filed herein.

Example 1. A method for processing a substrate includes loading the substrate on a substrate holder coupled to a scanning tool and disposed in a processing chamber, the substrate including an etch mask disposed over an underlying layer. The method further includes orienting, using the scanning tool, the substrate holder relative to a plasma torch at a tilt angle, the plasma torch being disposed in the processing chamber and including a plasma nozzle. And the method further includes generating, using the plasma torch, a plasma jet over an area of the substrate holder, and scanning, while maintaining a distance between an end of the plasma nozzle and a surface of the substrate, the substrate relative to the plasma jet to form features on the underlying layer at the tilt angle.

Example 2. The method of example 1, where orienting the substrate holder at the tilt angle includes aligning the plasma nozzle to direct a plasma beam along a vertical direction, and aligning the substrate holder along a first plane having a surface normal that is inclined with the vertical direction at the tilt angle. And where the scanning includes moving the substrate holder along the first plane and moving the plasma nozzle along the vertical direction to maintain the distance between the end of the plasma nozzle and the surface of the substrate.

Example 3. The method of one of examples 1 or 2, further including generating a plasma formed from SF₆ and O₂ and ejecting the plasma from the plasma nozzle towards the substrate.

Example 4. The method of one of examples 1 to 3, where the underlying layer includes glass.

Example 5. The method of one of examples 1 to 4, where the underlying layer is removed at an etch rate of 10 nm/min to 10,000 nm/min.

Example 6. The method of one of examples 1 to 5, where the scanning further includes changing a relative speed of the substrate holder with respect to the plasma nozzle to maintain a uniform exposure.

Example 7. The method of one of examples 1 to 6, where the scanning further includes maintaining an exposure by changing power applied to the substrate holder.

Example 8. A method for processing a substrate includes forming an etch mask for an optical grating over a layer of glass, and loading the layer of glass with the etch mask into a plasma chamber including a plasma torch. The method further includes generating a plasma jet at an exit nozzle of the plasma torch. And the method further includes scanning the plasma jet over the etch mask, the plasma jet being tilted relative to a major surface of the layer of glass during the scan so as to form the optical grating in the layer of glass with tilted features.

Example 9. The method of example 8, where scanning the plasma jet includes maintaining a distance between an end of the exit nozzle and the major surface.

Example 10. The method of one of examples 8 or 9, further including orienting the layer of glass at a tilt angle before the scanning.

Example 11. The method of one of examples 8 to 10, where orienting the layer of glass at the tilt angle includes aligning the exit nozzle to direct the plasma jet along a vertical direction, and aligning the layer of glass along a first plane having a surface normal that is inclined with the vertical direction at the tilt angle. And where maintaining the distance includes moving the layer of glass along the first plane, and moving the exit nozzle along the vertical direction to maintain the distance between the end of the exit nozzle and the surface of the substrate.

Example 12. The method of one of examples 8 to 11, where the layer of glass is removed at an etch rate of 1 nm/min to 1,000 nm/min.

Example 13. The method of one of examples 8 to 12, where generating the plasma jet includes generating a plasma formed from SF₆ and O₂ and ejecting the plasma from the exit nozzle towards the layer of glass.

Example 14. The method of one of examples 8 to 13, where the scanning further includes changing a relative speed of the layer of glass with respect to the exit nozzle to maintain a uniform exposure.

Example 15. The method of one of examples 8 to 14, where the scanning further includes maintaining an exposure by changing power applied to a bottom electrode supporting the layer of glass.

Example 16. A system for plasma processing includes a processing chamber, and a plasma torch disposed in the processing chamber and configured to emit a plasma jet along a vertical direction, the plasma torch coupled to a height motor to change a position of the plasma torch along the vertical direction. The system further includes a scanning tool coupled to a substrate holder in the processing chamber, the scanning tool configured to scan the substrate holder along a plane with a surface normal that is tilted relative to the vertical direction during a scanning operation. The system further includes an RF power supply electrically coupled to the substrate holder, a controller coupled to the scanning tool and the height motor, and a memory coupled to the controller and storing instructions to be executed in the controller. The instructions when executed cause the controller to synchronize the scanning tool with the height motor during the scanning operation.

Example 17. The system of example 16, where the controller is further coupled to a plasma generator, and the RF power supply, where the instructions when executed further cause the controller to incline, using a tilt drive, the substrate holder at a tilt angle, generate, using the plasma generator, the plasma jet over the substrate holder, bias, using the RF power supply, the substrate holder, and synchronously drive the height motor, and the scanning tool to cause a parallel raster pattern to be traced on the substrate holder by the plasma jet while maintaining a vertical displacement between the plasma torch and the substrate holder such that a size of an area of the substrate holder exposed to the plasma jet is maintained throughout the parallel raster pattern.

Example 18. The system of one of examples 16 or 17, where the substrate holder includes an electrostatic chuck.

Example 19. The system of one of examples 16 to 18, where the scanning tool includes a first rotary drive disposed in a scanning chamber and configured to rotate around a first axis, a second rotary drive disposed in the scanning chamber and configured to rotate around the first axis synchronously with the first rotary drive, a tilt drive configured to angle a normal direction of the substrate holder relative to a jet direction of the plasma jet at a tilt angle, and a bar-and-hinge system disposed in the scanning chamber and mechanically coupled to the substrate holder, the hinge system configured to translate a rotary motion of the first rotary drive and the second rotary drive to a planar motion of the substrate holder.

Example 20. The system of one of examples 16 to 19, where the bar-and-hinge system includes a first passive hinge, a second passive hinge, and a third passive hinge, the first, the second, and the third passive hinges being configured to rotate around the first axis. The bar-and-hinge system further includes a first bar link rotatably coupling the second rotary drive to the third passive hinge, a second bar link rotatably coupling the second passive hinge with the third passive hinge, a third bar link rotatably coupling the first passive hinge with the second passive hinge, and a fourth bar link rotatably coupling the first rotary drive to the first passive hinge. And the bar-and-hinge system further includes a belted bar link supporting the substrate holder, the belted bar link being coupled to the second bar link through the third passive hinge.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for processing a substrate, the method comprising:
loading the substrate on a substrate holder coupled to a scanning tool and disposed in a processing chamber, the substrate comprising an etch mask disposed over an underlying layer;
orienting, using the scanning tool, the substrate holder relative to a plasma torch at a tilt angle, the plasma torch being disposed in the processing chamber and comprising a plasma nozzle, the tilt angle being an angle between the plasma torch and a normal direction of the substrate holder;
generating, using the plasma torch, a plasma jet over an area of the substrate holder; and
scanning, while maintaining a distance between an end of the plasma nozzle and a surface of the substrate, the substrate relative to the plasma jet to form features on the underlying layer at the tilt angle.

2. The method of claim 1, wherein orienting the substrate holder at the tilt angle comprises:
aligning the plasma nozzle to direct a plasma beam along a vertical direction, and
aligning the substrate holder along a first plane having a surface normal that is inclined with the vertical direction at the tilt angle; and
wherein the scanning comprising moving the substrate holder along the first plane and moving the plasma nozzle along the vertical direction to maintain the distance between the end of the plasma nozzle and the surface of the substrate.

3. The method of claim 1, further comprising generating a plasma formed from SF₆ and O₂ and ejecting the plasma from the plasma nozzle towards the substrate.

4. The method of claim 3, wherein the underlying layer comprises glass.

5. The method of claim 4, wherein the underlying layer is removed at an etch rate of 10 nm/min to 10,000 nm/min.

6. The method of claim 1, wherein the scanning further comprises changing a relative speed of the substrate holder with respect to the plasma nozzle to maintain a uniform exposure.

7. The method of claim 1, wherein the scanning further comprises maintaining an exposure by changing power applied to the substrate holder.

8. A method for processing a substrate, the method comprising:
forming an etch mask for an optical grating over a layer of glass;
loading the layer of glass with the etch mask into a plasma chamber comprising a plasma torch;
generating a plasma jet at an exit nozzle of the plasma torch; and
scanning the plasma jet over the etch mask, the plasma jet being tilted relative to a major surface of the layer of glass during the scan so as to form the optical grating in the layer of glass with tilted features.

9. The method of claim 8, wherein scanning the plasma jet comprises maintaining a distance between an end of the exit nozzle and the major surface.

10. The method of claim 9, further comprising orienting the layer of glass at a tilt angle before the scanning.

11. The method of claim 10, wherein orienting the layer of glass at the tilt angle comprises
aligning the exit nozzle to direct the plasma jet along a vertical direction;
aligning the layer of glass along a first plane having a surface normal that is inclined with the vertical direction at the tilt angle, and
wherein maintaining the distance comprises: moving the layer of glass along the first plane and moving the exit nozzle along the vertical direction to maintain the distance between the end of the exit nozzle and the surface of the substrate.

12. The method of claim 8, wherein the layer of glass is removed at an etch rate of 1 nm/min to 1,000 nm/min.

13. The method of claim 8, wherein generating the plasma jet comprises generating a plasma formed from SF₆ and O₂ and ejecting the plasma from the exit nozzle towards the layer of glass.

14. The method of claim 8, wherein the scanning further comprises changing a relative speed of the layer of glass with respect to the exit nozzle to maintain a uniform exposure.

15. The method of claim 8, wherein the scanning further comprises maintaining an exposure by changing power applied to a bottom electrode supporting the layer of glass.

16. A system for plasma processing, the system comprising:
a processing chamber;
a plasma torch disposed in the processing chamber and configured to emit a plasma jet along a vertical direction, the plasma torch coupled to a height motor to change a position of the plasma torch along the vertical direction;
a scanning tool coupled to a substrate holder in the processing chamber, the scanning tool configured to scan the substrate holder along a plane with a surface normal that is tilted relative to the vertical direction during a scanning operation;
an RF power supply electrically coupled to the substrate holder;
a controller coupled to the scanning tool and the height motor; and
a memory coupled to the controller and storing instructions to be executed in the controller, the instructions when executed cause the controller to synchronize the scanning tool with the height motor during the scanning operation.

17. The system of claim 16, wherein the controller is further coupled to a plasma generator, and the RF power supply, wherein the instructions when executed further cause the controller to
incline, using a tilt drive, the substrate holder at a tilt angle,
generate, using the plasma generator, the plasma jet over the substrate holder,
bias, using the RF power supply, the substrate holder, and
synchronously drive the height motor, and the scanning tool to cause a parallel raster pattern to be traced on the substrate holder by the plasma jet while maintaining a vertical displacement between the plasma torch and the substrate holder such that a size of an area of the substrate holder exposed to the plasma jet is maintained throughout the parallel raster pattern.

18. The system of claim 16, wherein the substrate holder comprises an electrostatic chuck.

19. The system of claim 16, wherein the scanning tool comprises:
a first rotary drive disposed in a scanning chamber and configured to rotate around a first axis;
a second rotary drive disposed in the scanning chamber and configured to rotate around the first axis synchronously with the first rotary drive;
a tilt drive configured to angle a normal direction of the substrate holder relative to a jet direction of the plasma jet at a tilt angle; and
a bar-and-hinge system disposed in the scanning chamber and mechanically coupled to the substrate holder, the hinge system configured to translate a rotary motion of the first rotary drive and the second rotary drive to a planar motion of the substrate holder.

20. The system of claim 19, wherein the bar-and-hinge system comprises:
a first passive hinge, a second passive hinge, and a third passive hinge, the first, the second, and the third passive hinges being configured to rotate around the first axis;
a first bar link rotatably coupling the second rotary drive to the third passive hinge;
a second bar link rotatably coupling the second passive hinge with the third passive hinge;
a third bar link rotatably coupling the first passive hinge with the second passive hinge;
a fourth bar link rotatably coupling the first rotary drive to the first passive hinge; and
a belted bar link supporting the substrate holder, the belted bar link being coupled to the second bar link through the third passive hinge.
